(19) United States
(12) Patent Application Publication
(10) Pub. No.: US 2015/0365379 A1
(43) Pub. Date: Dec. 17, 2015

(54) SYSTEM AND METHOD FOR MANAGING, CONTROLLING AND CONFIGURING AN INTELLIGENT PARENTAL CONTROL FILTER

(71) Applicant: Gryphon Online Safety, Inc., San Diego, CA (US)

(72) Inventors: John Jun Wu, San Diego, CA (US); John Seungtae Yi, San Diego, CA (US)

(21) Appl. No.: 14/737,490

(22) Filed: Jun. 12, 2015

Related U.S. Application Data
(60) Provisional application No. 62/011,525, filed on Jun. 12, 2014.

(51) Int. Cl. H04L 29/06; G06N 5/02

(52) U.S. Cl. CPC H04L 63/0245; G06N 5/02; H04L 63/101

(57) ABSTRACT

A system and a method for intelligently learning a list of allowed IP content at one or more internet connected devices by implementing an intelligent parental control means is provided. The means includes a router and a filter. The router monitors and records web based operations done at the internet connected devices during a learning mode to create a list of allowed IP content at the internet connected devices. The filter implements the list and accordingly allows and blocks the content. Further, a remote device communicating with the router via a central server remotely controls and configures the router and the filter. The remote device permits the router to approve or disapprove a blocked IP content, when the blocked content is accessed at the internet connected devices.

### CROSS-REFERENCE TO RELATED APPLICATION

This application claims benefit of U.S. Provisional Patent Application No. 62/011,525, filed Jun. 12, 2014, the disclosure of which is hereby incorporated by reference in its entirety.

### FIELD OF THE INVENTION

The present invention generally relates to parental control filters, and more particularly to systems and methods for managing, controlling and configuring intelligent parental control filters.

### BACKGROUND OF INVENTION

A parent or guardian desires to protect their home Internet by blocking certain websites or content from connected devices. In some cases, the parent has Internet filtering software installed on a computer or tablet. In other cases, a router is used and configured to block undesirable content. Current solutions are very difficult to use and time consuming to configure and set up. Typically, the white list/black list of allowed/disallowed content, respectively, must be manually entered by a user, which takes time, or added on a case by case basis.

Conventional software solutions are cumbersome or not available to install on all Internet connected devices for the home such as TV-connected gaming computer or internet TV. Therefore, they are restricted to only computing devices, such as desktop, laptop, mobile phones and the like. Also, many of the parental control solutions restrict child's access to the computing devices rather than implementing restrictions on the network from the devices.

Finally, hardware router solutions are very difficult to set up and configure. Current solutions also need the parent to be present to make changes to the configuration. A remote control on the inbound and outbound traffic through a parent's device does not provide access to the parents to change the configuration while being at a remote area, other than the place where the parental control is deployed. Therefore, the current solutions again restrict the reach of the parental control, and need the parents to be present for controlling and configuring the system for the control. Also, many solutions provides devices on which the filtration is implemented to notify a remote control device of the parent, but lack such notification methods on the router or filter itself.

Therefore, there exists a need to provide a system and a method for managing, controlling and configuring a parental control router or filter that intelligently learns a list of allowed/disallowed data, avoiding the need to manually feed this data. Also, there exists a need to provide a parental control from anywhere via a smart phone device, that avoids need for the parents to be present for controlling and configuring the system.

### SUMMARY OF INVENTION

An objective of the present invention is to provide a system and a method that intelligently detects and learns a list of allowed and disallowed content in a network.

Another objective of the present invention is to provide a system and a method that allows a parent to remotely control allowed and disallowed content within a network via a central server and a mobile computing device, further providing freedom to manage, control and configure the system from anywhere.

Another objective of the present invention is to collect data, from a variety of sources, that relates to parameters for determining allowed and disallowed content within a network, where the sources may include and are not limited to other parents providing ratings to websites, or IP addresses, other trusted sources from third parties, and the like.

Another objective of the present invention is to provide a rating system that is generated by parents that share a common value (value can be a shared interest, child's age, religious belief).

Another objective of the present invention is to provide a system that automatically detects which Ethernet port is WAN and which is LAN by examining the initial DHCP configuration messages, in order to simplify the installation and configuration process.

Another objective of the present invention is to provide a system and a method for parental control filter to automatically detect tampering and notifying a mobile device.

### BRIEF DESCRIPTION OF DRAWINGS

FIG. 1 illustrates a system for implementing internet access control, in accordance with an embodiment of the present invention.

FIG. 2 illustrates a system for remotely managing, controlling and configuring the filter 104, in accordance with an embodiment of the present invention.

FIG. 3 illustrates a method for creating a white-list of allowed internet content, in accordance with an embodiment of the present invention.

FIG. 4 illustrates a method for remotely managing, controlling and configuring a parental control filter, in accordance with an embodiment of the present invention.

FIG. 5 illustrates an exemplary method for implementing internet filter in a network in accordance with an embodiment of the present invention.

FIG. 6 illustrates an exemplary method for implementing internet filter in a network, in accordance with an embodiment of the present invention.

FIG. 7 illustrates an exemplary system showing components of the filter 104 in accordance with an embodiment of the present invention.

### DETAILED DESCRIPTION OF THE EMBODIMENTS

In the following detailed description of embodiments of the invention, numerous specific details are set forth in order to provide a thorough understanding of the embodiment of invention. However, it will be obvious to a person skilled in art that the embodiments of invention may be practiced with or without these specific details. In other instances well known methods, procedures and components have not been described in details, so as not to unnecessarily obscure aspects of the embodiments of the invention.

Furthermore, it will be clear that the invention is not limited to these embodiments only. Numerous modifications, changes, variations, substitutions and equivalents will be apparent to those skilled in the art, without parting from the spirit and scope of the invention.

The present invention provides a system and a method for implementing a parental control on one or more internet connected devices, such as a desktop, laptop, mobile phones, smart phones, TV, radio and the like, by installing an intelligent means within the network. Further, the present invention also provides a system and a method for remotely managing, controlling and configuring the intelligent means from a remote computing device or a mobile device, via a central server.

The intelligent means automatically creates a white list that contains allowed IP content on one or more internet connected devices. The intelligent means determines what IP content is flowing to the internet connected devices, analyses the IP content or traffic and uses an algorithm to create the white-list. When the internet connected device tries to access the content not included in the white-list, the intelligent means blocks or restricts the IP content from flowing to the internet connected devices.

The intelligent means in one embodiment is a filter device having a circuitry, a processor and one or more means to analyze the content flowing from the internet connected device to the internet gateway. In one implementation, the filter may be a device that is physically and logically built with the router. In another implementation, the router performs the function of the intelligent means for creating the white-list and the filter follows instructions as provided by the router and performs the function of allowing access to the white-list content while blocking access to blocked or unwanted content.

The intelligent means is communicatively connected to the remote computing device or the mobile device having an application. The application provides an interface to an administrator of the intelligent means to interact or to manage and configure the intelligent control means. The remote computing device or the mobile device may include a smartphone, tablets, ipad or any device with built-in smart connectivity features in a network.

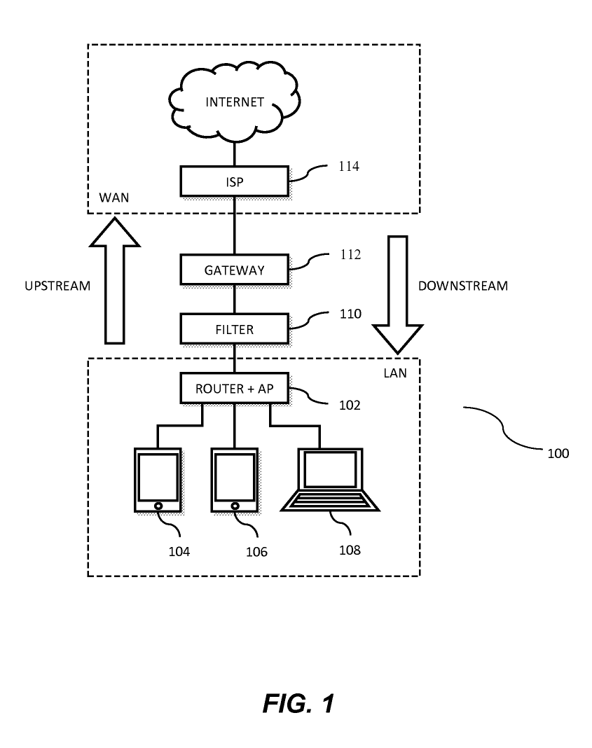

FIG. 1 illustrates a system for implementing internet access control, in accordance with an embodiment of the present invention. According to FIG. 1, a system 100 comprises one or more user devices 106 that are connected with the Internet. The user devices 106 may include but not limited to a desktop, a laptop, a tablet, a smart phone, an I-phone, an I-pad, a TV, a radio, a music system, and any device that is connected to Internet and may be used for web-browsing and web-streaming functions. The one or more user devices 106 are connected to an IP an internet service provider (ISP) 110 through a gateway 108. A router 102 facilitates the connection of two or more user device 106 simultaneously to the internet service provider 110. The gateway 108 can be a cable of a DSL modem and the router 102 can include the provision of Wi-Fi connectivity. The system 100 further comprises a filter 104 that serves as a means to block or allow access to the content flowing between the one or more user devices 106 and the internet service provider 110. The filter 104 can be physically and/or logically configured in the system 100.

The filter 104 can be configured to restrict access to undesired or unwanted internet content, thus can effectively serves as a control means for restricting a user from accessing unwanted material from the internet connected user devices 106. The control may be implemented at home for restricting children, or at schools for students, or at offices for employees, or anywhere else where a restricted access is required.

The content flowing between one or more user devices 106 and the internet service provider 110 can include websites, URLs, IP addresses, ports, internet protocols, media or specific traffic being accessed from the internet connected user devices.

The filter 104 is configurable to operate in a learning-ON mode and a regular mode. When operated in the learning-ON mode, the filter 104 monitors and analyzes the content being browsed by a user at any of the internet connected user devices 106. The content that have been browsed or watched during the learning-ON mode and the parameters associated with the content is recorded by the filter 104 during the learning-ON mode. Apart from the normal content, any content data which is not based on the web-browser is also monitored and recorded by the filter 104 during the learning-ON mode. The content data which are not based on web-browser comprises the internet content that is streamed at one or more internet connected user devices 106, such as a live show at an internet connected TV set, or a media content being streamed at an internet connected radio etc. Therefore, the filter 104 also monitors the usage of the web-based applications on one or more internet connected user devices 106, along with the browsing activities performed at the internet connected user devices 106. The web-browser based data as well as the content not associated with the web-browser is recorded and stored in form of a white-list. The white-list contains a list of allowed IP content is created that includes the websites, URLs, domains, and the like activities performed at the web-browser along with the IP content that is streamed from the wed, using the internet connected user devices 106. The white-list is automatically generated at the filter 104 without having the user manually entering the details of site that need to be allowed.

In an embodiment of the present invention, the white list includes a list of URLs, IP addresses, ports address, internet protocols, or specific traffic pattern. When building white list in the learning mode, the recorded internet addresses or port addresses visited is used to derive a more comprehensive white list. The visited internet or port address and all internet or port address referenced in its referenced pages are added to the white list. In some implementations, the referenced pages are limited to those in the same domain.

During the regular mode of operation, the filter 104 screens and analyzes a request for accessing an internet content coming from the user device 106, and compare the request with the list of allowed content in the white-list. If a match between the request and the white-list occurs, then the user device 106 is allowed to access the internet activity. If the request does not contain the content included in the white-list, the filter 104 blocks the request to access the content.

In an embodiment, the filter 104 is configured to operate in the learning-ON mode for a predetermined time. In some implementation consistent with the subject matter described herein, the learning-ON mode is automatically shut off after a certain amount of time, an/or after a certain amount of time of inactivity. When the learning-On mode is shut off, the filter 104 automatically transits to the regular mode of operation. During the regular mode the filter 102 screens and blocks access of the user device 106 to the content which are not listed in the white-list.

In an embodiment the transition between the learning-On mode and the regular mode of the filter 104 can be done manually by turning on/off one or more mechanical switches provided on the filter device 104. In another implementation the transition between the learning-ON mode and the regular mode of the filter 104 is controlled by the administrator that can remotely manage and control the configuration of the filter 104. The administrator can control/configure the filter 104 by using a smartphone or a mobile device with a web-based application. The application is in two-way communication with the filter 104 and using the application the administrator can configure the filter 104 for transition of learning-ON mode and the regular mode. In another implementation, the administrator can control/configure the filter 104 through a remote control device.

In an embodiment of the present invention, the filter 104 can be physically or logically built within the router 102 or a network bridge. In another implementation, the router 102 may perform the function of the filter 104. In another implementation the router 102 may perform the function of creating the white-list in learning-ON mode and the filter 104 follows instructions as provided by the router and performs the function of allowing access to the white-list content while blocking access to blocked or unwanted content. In another implementation, the filter is configured within the network bridge.

In another embodiment, a rating system is provided that may help in refining the content present in the white-list. The rating system includes ratings provided by one or more users to the internet content based on one or more parameters. The ratings depict the understanding, influence, thoughts, and affinity of the users about a particular internet content. If a website is rated low by a user it means that the user believes the particular website is not appropriate to be accessed. Further, the ratings may depend on certain parameters, such as shared interest, child's age, religious belief and the like. Therefore, the administrator may consider the ratings of the internet content provided by other users who share such common parameters. Advantageously, the rating system helps the administrator of the filter device 104 in determining a list of allowed content and to further refine the white-list created during the learning-ON mode of the filter 104.

The system 100 may provide a rating module that allows the users to rate the internet content, such as a website, a video on the web, a particular web streamed TV show or a movie, and the like. Preferably, users such as parents, guardians, teachers etc. give ratings or votes to the internet content. The users may vote to approve or block a particular content, such as a website, using a computing device, such as a smart phone. Additionally, the users may provide ratings such as to quantifying the appropriateness of the content. Each vote and the ratings are gathered and stored at a server database that is accessible by the computing device. Further, the ratings may be done based on one or more parameters such as interests, users' age, beliefs, religion and the like.

In an embodiment, each vote/rating may be categorized by a community of users with similar interests, or categorized by the users' child's age range. When the user is voting to allow or disallow, information is presented to the user about the voting results from before of other users. The voting results shown are based on a category of interest common to the user, and/or are shown as weighted by the social network relevance of the votes of other users to the current user.

A community curated list and rating system can be used that is generated by the users that share a common value (value can be a shared interest, child's age, religious belief). The rating can be weighed by a formula that contains shared values and proximity along with what is deemed acceptable by the administrator. In an embodiment, the community curated white list can be generated by institutions like schools where teachers can create lists of allowed websites for homework and this white list is subscribed to by parents.

The data collected from the rating system can be used by the filter 104 for further refining the allowable internet content as present in the white-list. Furthermore, data from other trusted sources may also be considered while determining the white list. Therefore, the system 100 efficiently collects data that is helpful in determining the white list of allowed internet content. This data includes browsed and streamed, the data rated by the second users, and the data from other trusted sources. While the browsed and streamed internet content is saved during the learning-ON mode of the filter 104; the data rated by the other users and the data from other trusted sources is continuously gathered when the filter is in either of learning-ON mode or the regular mode.

The filter 104 saves the information related to internet content, analyses the internet content and applies an algorithm to intelligently learn the white-list containing allowed internet content. The algorithm may take into consideration a number of parameters, such as interest, child's age, religious belief and the like. The parameters may also be selected by the users based on the characteristics of the administrator. In an embodiment of the present invention, the algorithm may adjust the list of allowed IP traffic based on age appropriateness over time. For example, a parent or guardian having young children may initially set the filter 104 to display material appropriate for children of ages 2 through 5. After a predetermined period of time (e.g., three years), the filter 104 can automatically change its settings to display content appropriate for children in the next age bracket (i.e., ages 6 through 9). These adjustments allow the filter 104 to automatically change the allowed content as its user's age.

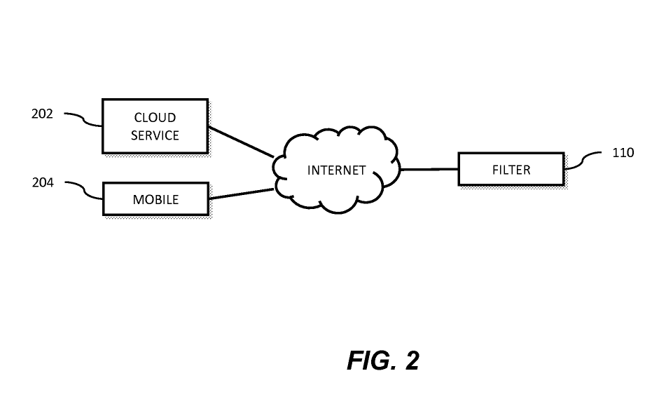

FIG. 2 illustrates a system for remotely managing, controlling and configuring the filter 104, in accordance with an embodiment of the present invention. The filter 104 is remotely configurable by the administrator, such as parents, guardians, teachers, employers and the like who can remotely manage or control the internet access by users, such as children, students, employees and the like. The administrator can remotely manage and configure the filter 104 via a mobile device 202 which is a computing device, such as a mobile phone, a smart phone, an I-Pad, a tablet, and the like. Preferably, the computing device is a smartphone.

The mobile device 202 is communicatively coupled with the filter 104 through the internet via a central server 204. The administrator such as a parent, may not only monitor the activities performed at the one or more internet connected user devices 106, but may also control and configure the filter 104 remotely. The central server 204 acts as a communication relay that allows bidirectional real time communication between the filter 104 and the mobile device 202.

When a user tries to access a blocked internet content from the user device 106, the filter 104 redirects the user to a web page where the user can interact with and request for permission to go to the site by clicking on a web interface. The filter 104 establishes a connection with the mobile device 202 and sends a notification to the mobile device 202 for requesting assistance to configure the filter 104.

The administrator receives the information, such as the IP address, web site and the like that identifies the internet content that is being requested by the user for granting the access. After examining the information, the administrator may or may not allow the user to access the blocked content from the internet connected user devices 106. Consequently, the administrator remotely configures the filter 104 to allow or not allow the blocked internet content. In an embodiment, the mobile device 202 may also receives a rating given to the particular blocked content by other users of similar shared interests, or user's age, beliefs or other parameters, or ratings from other trusted sources, when assisting the filter for its configuration. The rating may help the administrator in deciding whether to allow or not allow the blocked content. In one implementation, the mobile device may also be notified of the reason for blocking the internet content.

In an embodiment, the notification to the mobile device 202 for configuring the filter 104 can be made over the internet connection or a short message service. In an embodiment, the mobile device 202 may receive the notification with information about the blocked IP content such as the internet address, port address, URL, website etc., along with the ratings given to that particular IP content from other users of similar interests or similar community, and the reasons of blocking the IP content. In an additional embodiment, the mobile device 202 may receive a screen shot of the webpage.

If the administrator approves the request of the user device 106 for accessing the blocked content, the configuration of filter 104 changes. The particular internet content which was blocked earlier and now granted permission to access, is added to the white-list and the white-list is updated, thereby updating the configuration of the filter 104.

The mobile device 202 contains a web-based application that communicates with the filter 104 through the central server 204. One filter 104 is associated with only one web-based application on the mobile device that prevents controlling the filter 104 through more than one administrator. The administrator may log into the application for monitoring and controlling the filter 104. The administrator receives notifications of the web based activities performed at the internet connected user devices 106, and is alerted whenever a blocked website, or activity is being operated the user device 106. The administrator responds back accordingly to allow or disallow the operation of the activity. For example, the administrator may allow for the access of a particular blocked website through the web-based application, and hence the website is subsequently added to the white list.

In an embodiment of the present invention, the filter 104 comprises two network interface serving as input/output ports to the gateway 108 and the router 102; a processor unit that can process the content flowing in and out; a memory storage module to store lists needed for website/content filtering; and a logic that implements the filtering method to determine the white list.

The network interface serving input/output port to the gateway 108 is WAN port and the network interface serving input/output port to the router is LAN port. The filter 104 may examine network protocol traffic in order to determine the assignment of the LAN and WAN network to each of its network interfaces, where the WAN network can be resolved by the detection of any DHCP server messages. Alternatively, the filter 104 can examine network protocol traffic in order to determine the assignment of the LAN and WAN network to each of its network interfaces where the LAN network can be resolved by the absence of any DHCP server messages.

In another embodiment, the filter 104 notifies the mobile device 202 when any of the router 102 or the filter 104 id tampered with. The filter 104 sends a periodic notification to the mobile device 202 through a cloud service proxy 204 using an algorithm notifying about the status of the router 102 and the filter 104. Detection of the tamper status of either of the router 102 or the filter 104 depends on the absence of the periodic notification to the mobile device 202. Alternatively, the filter 104 can send a notification to the mobile device 202 on filter status transitions. The algorithm for detecting the tamper status is preferably done by monitoring the Ethernet link state of the WAN and LAN ports, and/or by detecting any configuration changes of the filter 104, the gateway 108, of the router 102 or the network bridge.

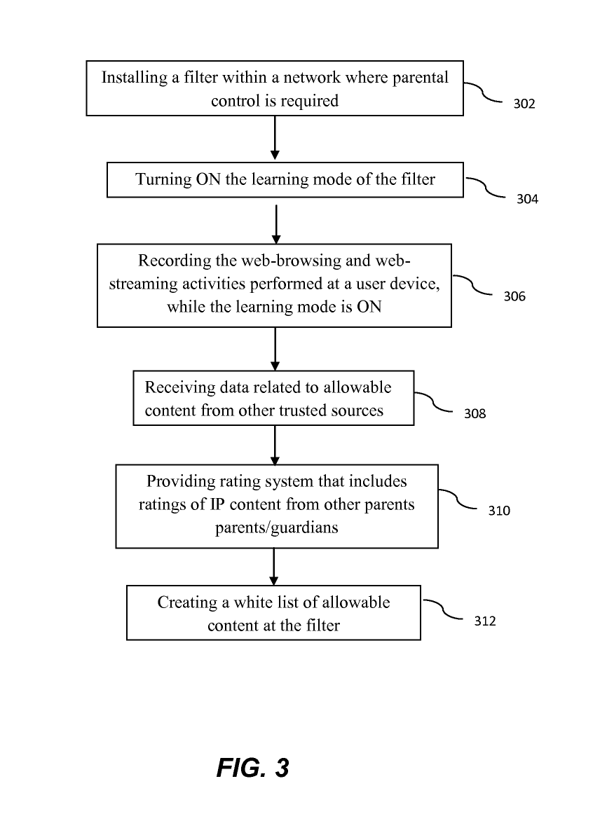

FIG. 3 illustrates a method for creating a white-list of allowed internet content, in accordance with an embodiment of the present invention. Beginning at step 302, the filter 104, is installed within the network where parental control is required. In one aspect the filter can be configured within a router or a network bridge. Once the set-up is ready, the filter 104, intelligently detects assignment of the LAN and WAN network. The filter 104 can have two or more connected network interfaces to examine network protocol traffic in order to determine the assignment of the LAN and WAN network to each of its network interfaces, where the WAN network can be resolved by the detection of any DHCP server messages. Alternatively, the parental control filter can examine network protocol traffic in order to determine the assignment of the LAN and WAN network to each of its network interfaces where the LAN network can be resolved by the absence of any DHCP server messages.

Proceeding to step 304, the learning mode of the filter 104 is turned on. In order to provide the filter 104 for intelligently learn the allowed internet traffic, the filter 104 must be in a learning mode. Therefore, the filter 104 learns the allowed internet traffic during the learning-ON mode.

Proceeding to step 306, during the learning-ON mode of the filter 104, the web based activities of a user performed at one or more internet connected user devices 106 are monitored and recorded. The web based activities may include and are not restricted to web browsing and web streaming.

Advancing to step 308, the filter 104 receives allowable data from other trusted source. The system 100 also fetches data gathered by other trusted sources, such as certified web-portals running polls for knowing internet traffic deemed appropriate by a community of users, and the like. The filter 104 receives this data also that is provided by the other trusted sources related to IP traffic that should be allowed and not allowed for different groups of users.

Advancing to step 310, provisions for rating or voting is also provided to determine the allowable and non-allowable internet traffic for different group of users. The ratings given to different websites, URLs, web-based application or any other IP traffic depict what other users, such as parents, teachers and the like think about the particular IP content. Ratings or votes to approve or block a website can be collected, where the vote is done on a computing device, and the vote result is then transmitted to and stored on a remote server's database connected to the computing device over the internet. Each vote is categorized by a community of users with similar interests, or categorized by the user's child's age range. When the user is voting to allow or disallow, information is presented to the user about the voting results from before of other users. The voting results shown are based on a category of interest common to the user, and/or are shown as weighted by the social network relevance of the votes of other users to the current user. Therefore, while creating a white list of allowed IP traffic, such ratings or voting from different users may also be considered.

Advancing to step 312, the data related to internet traffic that is monitored and recorded while the learning mode is ON, is further analyzed by the filter 104 implementing an algorithm in order to create a white-list of allowed internet traffic. In an embodiment, a collection of data, including the internet traffic that is monitored and recorded while the learning mode is ON, data provided from other trusted sources, and the data received from the rating system, may analyzed for creating the white-list.

The white-list may include and is not limited to a list of URLs, IP addresses, ports, internet protocols, or specific traffic pattern. When building a URL white-list in the learning mode, the recorded URL visited is used to derive a more comprehensive white-list. The visited URL and all URLs referenced in its referenced pages are added to the white-list. In some implementations, the referenced pages are limited to those in the same domain.

Therefore, the filter 104 intelligently determines a white-list of allowed IP traffic through an automated learning process during a learning-ON mode. In an embodiment, the learning mode may be activated through a computing device in the local network connected to the filter 104 or on the internet. In another embodiment, the learning mode may be remotely activated or deactivated from a remote device communicating with the router 102 or the filter 106 through Internet via a central server.

In yet another embodiment, the learning mode may be automatically shut off after a certain amount of time, and/or after a certain amount of time of inactivity. In another embodiment, the algorithm can adjust the list of allowed IP traffic based on age appropriateness over time. For example, a parent or guardian having young children may initially set the filter to display material appropriate for children of ages 2 through 5. After a predetermined period of time (e.g., three years), the filter 104 can automatically change its settings todisplay content appropriate for children in the next age bracket (i.e., ages 6 through 9). These adjustments allow the filter 104 to automatically change the allowed content as its user's age.

In an embodiment, a curated list of allowed IP traffic or content may have a shareable and non-shareable component, the sharable component may be downloaded and used by other users. Additional information is presented to the user during their rating process, where the information can contain categories based on the page content.

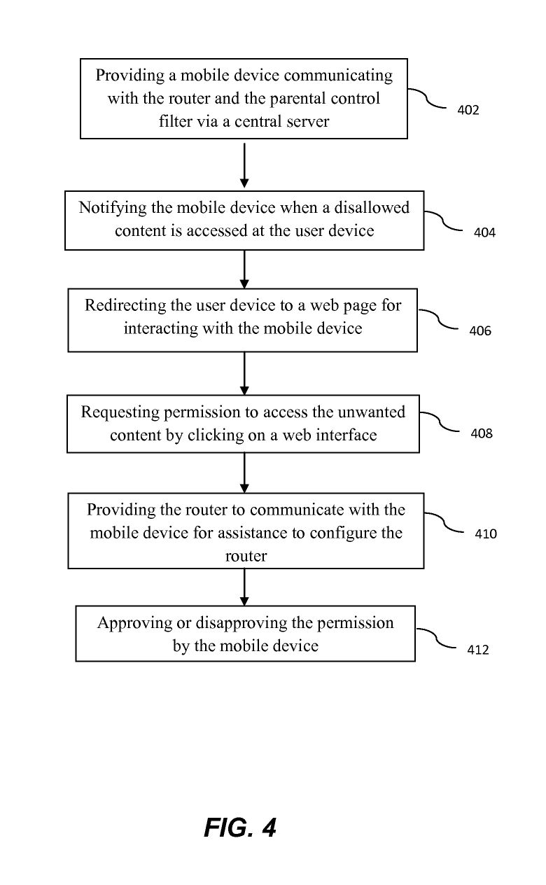

FIG. 4 illustrates a method for remotely managing, controlling and configuring a parental control filter, in accordance with an embodiment of the present invention. Beginning at step 402, the mobile device 202 is provided to manage and control the filter 104 by communicating with the filter 104 through a central server 204. Proceeding at step 404, as disallowed internet content is accessed at any one of the internet connected user device 106, the filter 104 notifies the mobile device 202 of disallowed access. Proceeding to step 406, the internet connected user device 106 is redirected to a web page for allowing the user to interact with the mobile device 202.

Proceeding to step 408, the user at the internet connected user device 106 requests for allowing access to the disallowed content by clicking on the web interface. For example, the web page may provide an interface that asks a question to the user for pushing a permission to the mobile device 202. In an additional embodiment, the filter may also provide identifying information about the blocked internet content to the mobile device 202. Thereafter, at step 410, the filter 104 communicates with the mobile device 202 for assistance to configure the filter 104. Consequently, at step 412, the administrator may approve or disapprove the permission using the mobile device 202. Thereby, the white-list is modified accordingly, and the filter 104 is configured with the modified white list. Hence, the filter 104 also operates according to the modified white list.

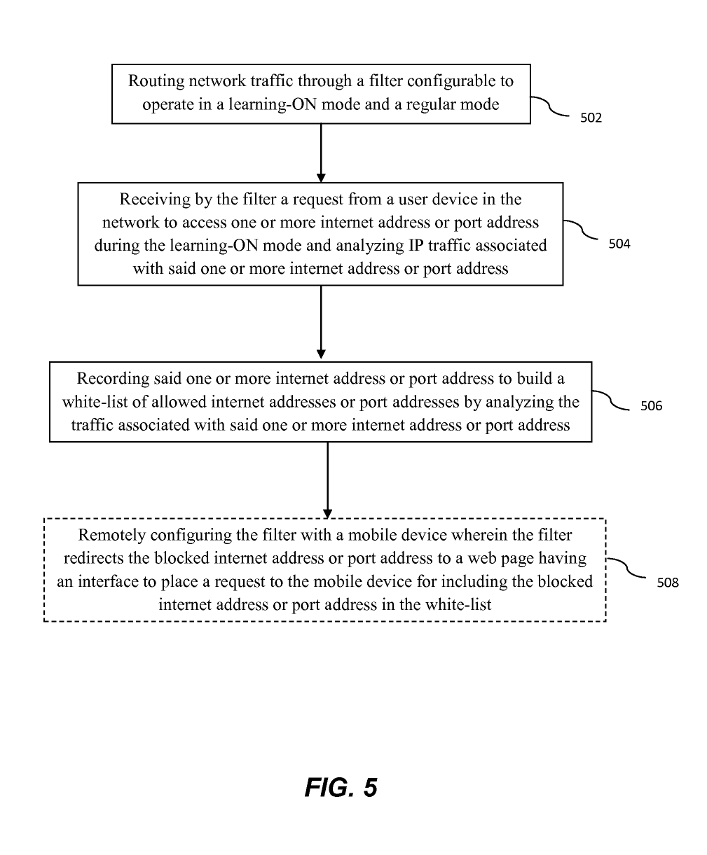

FIG. 5 illustrates an exemplary method for implementing internet filter in a network in accordance with an embodiment of the present invention. The method involves: at step 502, routing network traffic through a filter 104 configurable to operate in a learning-ON mode and a regular mode. Advancing to step 504, receiving by the filter 104 a request from a user device in the network to access one or more internet address or port address during the learning-On mode and analyzing IP traffic associated with said one or more internet address or port address. Advancing to step 506, recording said one or more internet address or port address to build a white-list of allowed internet addresses or port addresses by analyzing the IP traffic associated with said one or more internet address or port address. Advancing further to step 508, Remotely configuring the filter with a mobile device wherein the filter redirects the blocked internet address or port address to a web page having an interface to place a request to the mobile device for including the blocked internet address or port address in the white-list.

The white list comprises a list of URLs, internet address, IP addresses, a port address, an internet protocols or a specific traffic pattern visited by the filter while in learning-ON mode. The method involves configuring the filter in the learning-ON mode by the user device or by a remotely connected computing device. The method involves transitioning of the filter form the learning-ON mode to the regular mode after a predetermined interval of time.

The method further comprises the step of refining the white-list by further analyzing parameters of the internet addresses or the port addresses of the white-list. If an internet address or port address is not present in the white-list, then it is a blocked internet address or port address and the user is prevented to access the blocked internet address or port address. The filter 104 is in bi-directional communication with the mobile device through a server. The mobile device is notified of the request for including the blocked internet address or port address in the white-list through a notification that includes information about the blocked internet address or port address such as ratings and the reasons for blocking the address.

The white-list also comprises a community curated list and a rating system generated by a rating institution. The community curated list is created by collecting votes from a community of users with a similar interest to approve or block an internet address or port address. Each vote is characterized by user's child age and the curated list of web sites comprises a sharable and a non-sharable component, wherein the sharable component can be downloaded and used by users.

In an embodiment of the present invention, the filter can be configured in a router or a network bridge.

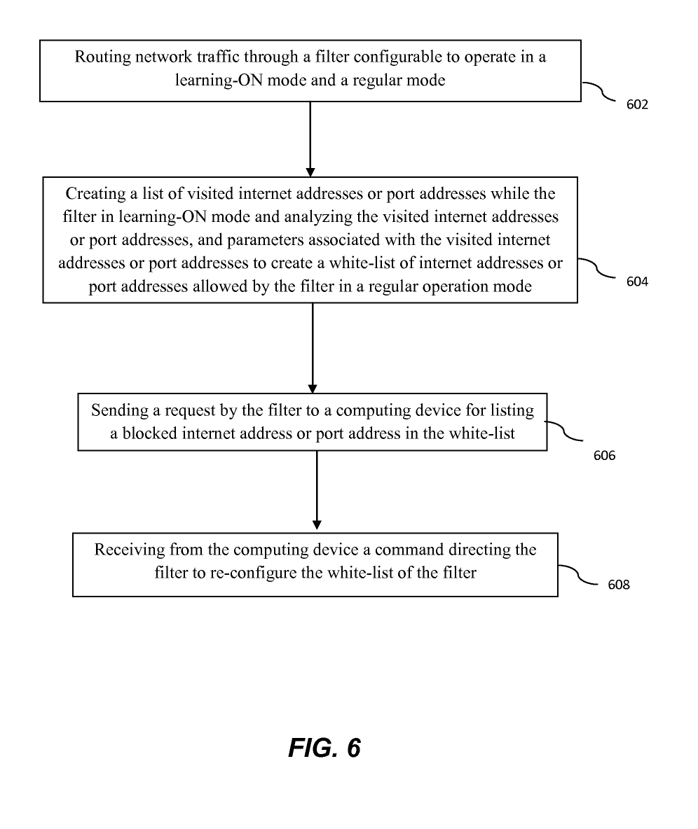

FIG. 6 illustrates an exemplary method for implementing internet filter in a network, in accordance with an embodiment of the present invention. The method involves: beginning at step 602: routing network traffic through a filter configurable to operate in a learning-ON mode and a regular mode. Proceeding to step 604: creating a list of visited internet address or port address while the filter in learning-ON mode and analyzing the visited internet address or port address, and parameters associated with the visited internet address or port address to create a white-list of internet address or port address allowed by the filter in a regular operation mode. Proceeding to step 606: sending a request by the filter to a computing device for listing a blocked internet address or port address in the white-list. Proceeding to step 608: receiving from the computing device a command directing the filter to re-configure the white-list of the filter. In one aspect, the step of re-configure the white-list of the filter comprises: configuring the blocked internet address or port address in the white-list of the filter or continue blocking the blocked internet address or port address.

The computing device may comprises a smartphone, a tablet or an iPAD with a web-based application. The request may include additional information about the blocked internet address or port address, rating of the blocked internet address or port address and reasons for blocking the internet address or port address. The filter may send the request to the computing device through a central server.

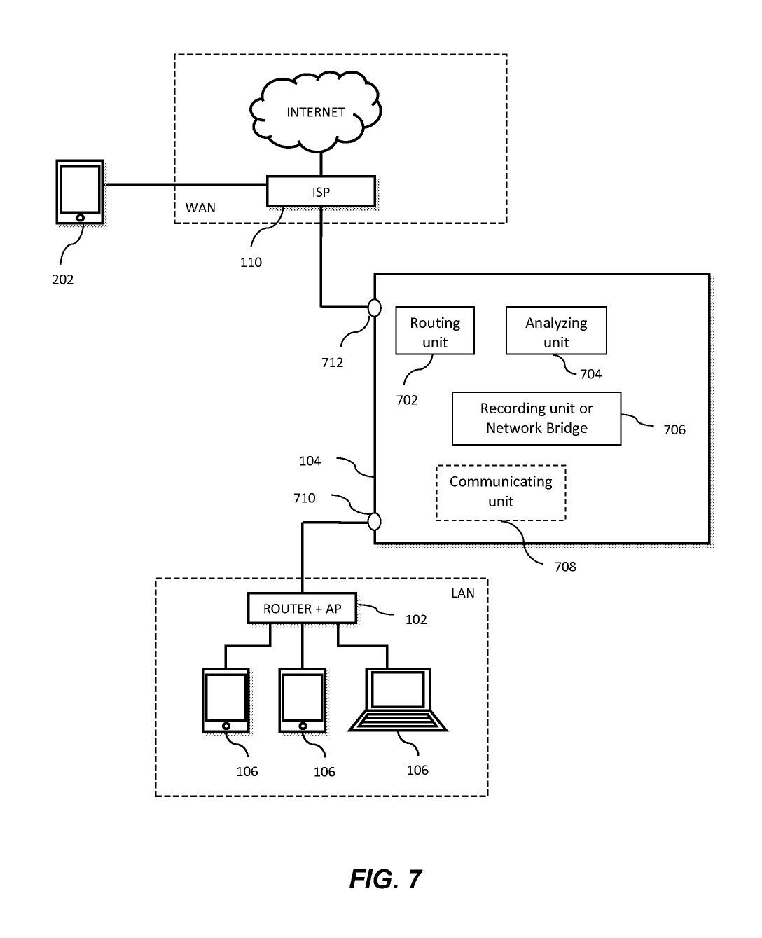

FIG. 7 illustrates an exemplary system showing components of the filter 104 in accordance with an embodiment of the present invention. The system comprises at least one user device 106 connected to the internet gateway 108 and a filter 104 connecting said at least one user device 106 to the internet gateway 108. The filter 104 is configurable to operate in a learning-ON mode and a regular mode. The filter 104 comprises: a routing unit or bridging unit 702 to receive requests from said at least one user device 106 to access one or more internet address or port address when the filter 104 is being operated in the learning-ON mode; an analyzing unit 704 to analyze IP traffic associated with each of said one or more internet address or port address request received by the routing unit or bridging unit 702; a recording unit 706 to create a white-list containing details of the each of said one or more internet address or port address requests received by the routing unit or bridging unit 702 while being operated in the learning-ON mode; a communicating unit 708 in communication with the mobile device 202 through a server. The routing unit or bridging unit 702 blocks access to an internet address or port address which is not listed in the white-list.

In one implementation the filter may be configured within a router or a network bridge. The filter 104 shut off the learning-ON mode and transits to the regular mode after a predetermined time interval or after a predefined time of inactivity of routing unit.

The routing unit or bridging unit 702 redirects a webpage of the blocked internet address or port address to a specific webpage which allows a user to request configuration changes in the white-list of the filter 104. The communicating unit 708 notifies the mobile device 202 for the request associated with configuration changes in the white-list.

In an embodiment of the present invention, the filter 104 comprises a first port 710 to connect said at least one user device and a second port 712 to connect with the internet gateway. The first port 710 and second port 712 are Ethernet port wherein the first port is LAN port 710 and the second port is WAN port 712. The filter automatically resolves WAN port by detecting DHCP server messages. Alternatively the filter 104 automatically resolves LAN port by detecting absence of DHCP server message.

In another embodiment, the filter 104 sends a periodic notification to a central server. The filter detects tampering of the filter in the event of absence of the periodic notification to the central server and the status of the filter is a tamper status. On detection of tamper status, the communicating unit sends a notification to the mobile device 202. The tamper status may be detected by monitoring the first port and second port of the filter.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid state memory or a magnetic hard drive or any equivalent storage medium. The machine-readable medium can alternatively or additionally store such machine instructions in a transient manner, such as for example as would a processor cache or other random access memory associated with one or more physical processor cores.

To provide for interaction with a user, one or more aspects or features of the subject matter described herein can be implemented on a computer having a display device, such as for example a cathode ray tube (CRT), a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including, but not limited to, acoustic, speech, or tactile input. Other possible input devices include, but are not limited to, touch screens or other touch-sensitive devices such as single or multi-point resistive or capacitive track pads, voice recognition hardware and software, optical scanners, optical pointers, digital image capture devices and associated interpretation software, and the like.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and sub combinations of the disclosed features and/or combinations and sub combinations of several further features disclosed above. In addition, the logic flows depicted in the accompanying figures and/or described herein do not necessarily require the particular order shown, or sequential order, to achieve desirable results. Other implementations may be within the scope of the following claims.

We claim:

1. A method for implementing an internet filter in a network comprising the steps of:
routing network traffic through a filter configurable to operate in a learning-ON mode and a regular mode;
receiving by the filter a request from a user device in the network to access one or more internet address or port address during the learning-On mode and analyzing IP traffic associated with said one or more internet address or port address; recording said one or more internet address or port address to build a white-list of allowed internet addresses or port addresses by analyzing the traffic associated with said one or more internet address or port address.

2. The method of claim 1, wherein the white-list comprises a list of internet address, IP addresses, a port address, an internet protocols or a specific traffic pattern visited by the filter while in learning-ON mode.

3. The method of claim 1 further comprising: configuring the filter in the learning-ON mode by the user device or by a remotely connected computing device.

4. The method of claim 1 further comprising: transitioning of the filter form the learning-ON mode to the regular mode after a predetermined interval of time.

5. The method of claim 1 further comprising: refining the white-list by further analyzing parameters of said one or more internet addresses or port address of the white-list.

6. The method of claim 1, wherein an internet address or a port address not present in the white-list is a blocked internet address or port address and preventing the user device to access the blocked internet address or port address.

7. The method of claim 1, wherein the filter is configured within a router or a network bridge.

8. The method of claim 1 further comprising: remotely configuring the filter with a mobile device wherein the filter redirects the blocked internet address or port address to a web page having an interface to place a request to the mobile device for including the blocked internet address or port address in the white-list.

9. The method of claim 8, wherein the filter is in bi-directional communication with the mobile device through a server.

10. The method of claim 8, wherein the mobile device is notified of the request for including the blocked internet address or port address in the white-list through a notification that includes information about the blocked internet address or port address such as ratings and the reasons for blocking the site.

11. The method of claim 1, wherein the white-list comprising a community curated list and a rating system generated by a rating institution.

12. The method of claim 11, wherein the community curated list is created by collecting votes from a community of users with a similar interest to approve or block an internet address or port address.

13. The method of claim 12, wherein each vote is characterized by user's child age.

14. The method of claim 11, wherein the curated list of web sites comprises a sharable and a non-sharable component, wherein the sharable component can be downloaded and used by users.

15. A method for implementing an internet filter in a network comprising the steps of:
routing network traffic through a filter configurable to operate in a learning-ON mode and a regular mode;
creating a list of visited internet addresses or port addresses while the filter in learning-ON mode and analyzing the visited internet addresses or port addresses and parameters associated with the visited internet addresses or port addresses to create a white-list of internet addresses or port addresses allowed by the filter in a regular operation mode;
sending a request by the filter to a computing device for listing a blocked internet address or port address in the white-list;
receiving from the computing device a command directing the filter to re-configure the white-list of the filter.

16. The method of claim 15, wherein the computing device comprises a smartphone, a tablet or an iPAD with a web-based application.

17. The method of claim 14, wherein step of re-configure the white-list of the filter comprises: configuring the blocked internet address or port address in the white-list of the filter or continue blocking said blocked internet address or port address.

18. The method of claim 15, wherein the request includes additional information about the blocked internet address or port address, rating of the blocked internet address or port address and reasons for blocking the internet address or port address.

19. The method of claim 15, wherein the filter sends the request to the computing device through a central server.

20. A system for filtering content in a network comprising:
at least one user device connected to the internet gateway;
a filter connecting the at least one user device to the internet gateway, the filter configurable to operate in a learning-ON mode and a regular mode, said filter comprising: a routing unit or a bridging unit to receive requests from said at least one user device to access one or more internet addresses or port addresses when the filter is operated in the learning-ON mode; an analyzing unit to analyze IP traffic associated with each of the said one or more internet address or port address request received by the routing unit or the bridging unit; a recording unit to create a white-list containing details of the each of the said one or more internet address or port address requests received by the routing unit or the bridging unit while being operated in the learning-ON mode.

21. The system of claim 20, wherein the routing unit or the bridging unit blocks access to an internet address or port address which is not listed in the white-list.

22. The system of claim 20, wherein the filter is configured within a router or a network bridge.

23. The system of claim 20, wherein the filter shut off the learning-ON mode and transits to the regular mode after a predetermined time interval or after a predefined time of inactivity of the routing unit or the bridging unit.

24. The system of claim 20 further comprising a communicating unit in communication with a mobile device through a server.

25. The system of claim 20, wherein the routing unit or the bridging unit redirects a webpage of the blocked internet address or port address to a specific webpage which allows a user to request configuration changes in the white-list of the filter.

26. The system of claims 24 and 25, wherein the communicating unit notifies the mobile device for the request associated with configuration changes in the white-list.

27. The system of claim 20, wherein the filter comprises a first port to connect said at least one user device and a second port to connect with the internet gateway.

28. The system of claim 27, wherein the first port and second port are Ethernet port.

29. The system of claim 27, wherein the first port is LAN port and the second port is WAN port.

30. The system of claim 29, wherein the filter automatically resolve WAN port by detecting DHCP server messages.

31. The system of claim 29, wherein the filter automatically resolve LAN port by detecting absence of DHCP server message.

32. The system of claim 20, wherein the filter sends a periodic notification to a central server.

33. The system of claim 32, wherein the filter detects tampering of the filter in the event of absence of the periodic notification to the central server and the status of the filter is a tamper status.

34. The system of claim 33, wherein the communicating unit in the filter sends a notification to the mobile device on detection of the tamper status of the filter.

35. The system of claim 33, wherein the filter detects the tamper status by monitoring the first port and the second port of the filter.
